(19) United States
(12) Patent Application Publication
(10) Pub. No.: US 2018/0230054 A1
(43) Pub. Date: Aug. 16, 2018

(54) HIGH-FLUIDITY CEMENTITIOUS COMPOSITION SUITABLE TO BE MOULDED, IN PARTICULAR INJECTION-MOULDED, TO MAKE A MANUFACTURED PRODUCT HAVING GOOD APPEARANCE

(71) Applicant: ITALCEMENTI S.P.A., Bergamo (IT)

(72) Inventors: Roberta ALFANI, Aix en Provence (FR); Giuseppe MANGANELLI, Bergamo (IT); Flavio RAMPINELLI, Urgnano (IT); Giovanni CIVIDINI, Bonate Sopra (IT)

(21) Appl. No.: 15/750,071

(22) PCT Filed: Aug. 3, 2016
(86) PCT No.: PCT/IB2016/054677

§ 371 Date: Feb. 2, 2018

(30) Foreign Application Priority Data
Aug. 3, 2015 (IT) 102015000041409

(51) Int. Cl. C04B 28/02; C04B 14/30; C04B 24/28; C04B 24/02; C04B 14/48

(52) U.S. Cl. CPC C04B 28/02; C04B 14/30; C04B 2103/32; C04B 24/02; C04B 14/48; C04B 24/286

(57) ABSTRACT

The invention relates to a cementitious composition suitable to be moulded, in particular injection-moulded, to make a manufactured product with arithmetic average surface roughness Ra not higher than 500 nm and flexural tensile strength not lower than 5 MPa, measured after 28 days of curing, the fluidity of the composition, measured according to the method of standard UNI 7044, being not lower than 185 mm, characterised in that it comprises at least: I. a hydraulic binder II. one or more aggregates III. an anti-shrinkage agent IV. a superplasticiser agent V. fibres VI. water, wherein said fibres are made of an amorphous metal material consisting of an alloy with composition (Fe, Cr)₈₀ (P, C, Si)₂₀ in form of flexible lamellae of length equal to at least 10 mm and elastic modulus equal to at least 80000 MPa, present in the composition in amounts by weight of less than 4% with respect to the weight of the composition.

### FIELD OF THE INVENTION

The present invention relates to a high-fluidity cementitious composition suitable to be moulded, in particular injection-moulded, to make a manufactured product having good appearance.

### BACKGROUND ART

The Applicant is the owner of application WO2013/037792 which describes a cementitious product, in particular slab-shaped, with controlled curling and surface roughness, made by casting a fluid composition comprising a hydraulic binder, one or more aggregates, an anti-shrinkage agent, a superplasticiser agent and water into a mould, in which the percentage by weight of said hydraulic binder in the composition is higher than that of said aggregates, and in which the aggregates have a maximum diameter which is not higher than one third of the thickness of the product, the final product thus having a mean arithmetic surface roughness Ra no higher than 500 nm.

The controlled roughness under such a limit translates into a surface which is homogenous and smooth to the touch and has a good appearance result. The gloss thus obtained may appear as a mirror surface of considerable decorative value.

However, casting is not an ideal forming method for cementitious products having complex shape and geometry other than a slab, e.g. products for which moulds with voids which are difficult to fill, such as a corners and undercuts, are required. In such cases, it would be more suited to use a pressurised moulding process, such as injection moulding, for example. In such a case, a first requirement of the cementitious mixture to be subjected to injection is high fluidity, so that the mortar can run easily and uniformly into all empty voids of the mould.

However, according to the objects of the present invention, the product to be formed must have high quality mechanical properties, such as, for example, high compression and flexural strength, in addition to having controlled surface roughness Ra for good appearance results, and possibly also complex shape, which can thus be injection moulded.

Cementitious mixtures reinforced with the addition of fibres, e.g. of metal or in plastic material, are known for this purpose; however, in general, the addition of fibres to the mixture, either of metal or made of plastic or other material, considerably reduces the fluidity required for injection moulding. Furthermore, the fibres are an obstacle also with regards to the desired surface roughness to be contained under the predetermined limit according to the objects of the invention, in general because they tend to emerge and become apparent in the surface zones of the product, thus damaging the appearance effect sought.

As can be seen, the technical problem dealt with here is rather complex to solve, because satisfying one of the desired properties of the end product may mean contrasting the others.

It is the object of the present invention to devise cementitious based compositions, which are reinforced in order to reduce the typical fragility of the cementitious products obtained therefrom, provided with rheological properties such to be easily moulded by injection in addition to by casting. In addition to having mechanical strength, the products made according to the present invention must be smooth and homogenous to the touch and have good appearance results.

The desired rheological properties of the cementitious composition according to the present invention are mainly: high plasticity, meaning the capability of the material to be shaped; high initial fluidity, defined initial consistency, meaning the ability of the material to flow, measured according to a method processed by the Applicant according to standard UNI 7044 (1972), which will be described below; workability retention, meaning the measurement of the ease of the composition to be worked and cured to obtain the product (Cf.: Measurement of Rheological Properties of High Performance Concrete: State of the Art Report, Chiara Ferraris, 1996, Doc. NISTIR 5869).

Low fragility, according to the present invention, means low tendency of the final cementitious product to break unexpectedly without the occurrence of deformations or yielding. With this regard, the addition of fibres to cementitious mixtures reduces its rheological properties, in particular the initial consistency, as defined above. Such an effect is particularly apparent in the case of UHPC (Ultra High Performance Concrete, Cf.: Graybel, B. (2009), UHPC Making Strides, Public Roads Vol. 72, no 4, p. 17-22, Federal Highway Administration, McLean, Va.). UHPC refers to cementitious materials with a water/cement ratio lower than 0.25 and a high percentage of discontinuous fibres such to produce mechanical compression strengths higher than 150 MPa and mechanical flexural strengths higher than 5 MPa. The cementitious mixtures reinforced with fibres are generally processed by casting into flat geometry moulds. Metal fibres, specifically steel, are among the most commonly used fibres for reinforcing.

Patent application FR 2765212 describes the use of thin amorphous metal fibres, there defined ribbons or straps, added to cementitious mixtures to reduce the fragility thereof. The concerned fibres consist of a metal alloy having composition (Fe, Cr)₈₀, (P, C, Si)₂₀ and are added to the cementitious mixture in quantity by weight comprised between 4% and 40% with respect to the weight of the composition. Such mixtures are thus subjected to casting for making the reinforced cementitious products. The cementitious products thus made by casting have low fragility and high durability. In such document, there is no interest for other properties of the product, such as roughness or other appearance, or elaborate shapes of the product, which require moulding methods other than casting.

In particular, polyvinyl alcohol (PVA) and polypropylene (PP) are particularly known among the reinforcement fibres made of plastic material. As mentioned, they also generate a decrease of fluidity when added to cementitious mixtures in sufficient amount to reduce the fragility of the finished product.

### DESCRIPTION OF THE INVENTION

According to the objects of the present invention, instead, it is a fundamental requirement to be able to avail of a high-fluidity cementitious mixture, such to be moulded, also by injection, to obtain reinforced manufactured products of even complex shape, while respecting all the other requirements listed above. In particular, it is desirable to have manufactured products with good appearance results and uniform colour, and which do not display faults, typically such as so-called honeycombs or air bubbles, shrinkage crazing or curling.

In order to achieve such objects as a whole, the present invention suggests a cementitious composition suitable to be moulded, in particular, but not exclusively by injection, to make a manufactured product with arithmetic average surface roughness Ra not higher than 500 nm and flexural tensile strength not lower than 5 MPa, measured after 28 days of curing, the fluidity of the composition measured according to the method described below deriving from standard UNI 7044 being not lower than 185 mm, preferably not less than 220 mm, and more preferably not less than 240 mm, characterised in that it comprises at least:

I. a hydraulic binder

II. one or more aggregates

III. an anti-shrinkage agent

IV. a superplasticiser agent

V. fibres

VI. water,

wherein said fibres are made of an amorphous metal material consisting of an alloy with composition (Fe, Cr)₈₀ (P, C, Si)₂₀ in form of flexible lamellae of length equal to at least 10 mm and elastic modulus equal to at least 80000 MPa, present in the composition in amounts by weight of less than 4% with respect to the weight of the composition.

Said flexural tensile strength being in line with ASTM C1018, as described below. Said 28 day curing is performed according to standard UNI 196-3.

According to the invention, the composition is suitable to be injection moulded, preferably under pressure comprised between 0.1 and 50 bar, more preferably between 0.2 and 30 bar, and even more preferably between 0.3 and 10 bar, in hydraulically or mechanically closed moulds.

The composition of the present invention, particularly in the case in which the geometry of the shape of the manufactured product is not particularly complex, may also be moulded by casting or by means of other suitable forming method.

### DETAILED DESCRIPTION OF THE INVENTION

Components from I to V of the composition according to the present invention will now be described in detail.

I. The hydraulic binder is a powder material in solid dry state which, when mixed with water, provides plastic mixtures capable of setting and curing, even under water, such as cement. A clinker which can be used for preparing a binder for the present invention is any common cement clinker, defined according to standard UNI EN 197.1, i.e. a hydraulic material consisting of at least two thirds by mass of calcium silicates (3CaO.SiO₂) and (2CaO.SiO₂), the remaining part being Al₂O₃, Fe₂O₃ and other oxides; for example, a Portland cement clinker.

The broad definition of hydraulic binder according to present invention comprises white, grey or pigmented cements, defined according to the aforesaid standard UNI EN 197.1, and the so-called cements for concrete retaining works, cementitious binders and hydraulic mortars, as defined by Italian Law 26 May 1965 N. 595, and inorganic silicates.

According to the present invention, calcium sulfoaluminate based binders may be used, such as the compounds described in patents and/or patent applications WO2006/18569, EP-A-1306356 and EP-A-0181739, and those derived from calcium sulfoaluminate clinkers described in the Review “Green Chemistry for sustainable cement production and Use” by John W. Phair Green Chem., 2006, 8, 763-780, in particular in chapter 5.3 on page 776, and also by calcium sulfoaluminates clinkers described in the article “Calcium sulfoaluminates cements—low energy cements, special cements” J. H. Sharp et al., Advances in Cement Research, 1999, 11, n.1, pp. 3-13.

Alternatively, aluminous cement and iron-sulphur aluminous cement may also be used, as described in Advances in Cement Research, 1999, 11, No. 1, January, 15-21. According to the present invention, photocatalytic cements may also be used, i.e. binders having photocatalytic activity obtained by adding a photocatalyst to the mixture capable of oxidising the polluting organic and inorganic substances present in the environment in present of light, air and environmental humidity.

The photocatalyst may be chosen among any compound capable of oxidising the polluting substances which come into contact with the surface of the cementitious compositions in cured state in presence of light, oxygen and water, naturally providing that they do not counter-productively affect the physical-mechanical properties of the cementitious compositions used in the invention.

The preferred photocatalyst according to the present invention is titanium oxide or a precursor thereof, and more typically titanium oxide at least partially in form of anatase. The expression “titanium oxide at least partially in form of anatase” means that the particles of titanium oxide have anatase structure for at least 5%, preferably 25%, more preferably at least 50%, even more preferably at least 70% as percentages by weight on the total titanium oxide. Examples of photocatalytic cements are the products of the TX® range (Italcementi), such as TX Active®.

In a preferred embodiment of the invention, Alipre® Cement (Italcementi) calcium sulfoaluminate as binder, Ultracem® 52,5R Portland (Italcementi) cement, Italbianco® 52,5 R (Italcementi) white cement and TX Arca® (Italcementi) cement are used.

A composition according to the present invention may also optionally comprise anhydrite or chalk.

II. The aggregates or inert materials, also known as inert aggregates, according to the present invention may comprise:
fine aggregates, such as fillers, powders and sands, defined in standards UNI EN 13139 and UNI EN 12620; according to the present invention, filler means a fine aggregate fraction having maximum diameter, dmax, smaller than 100 mm, and more preferably smaller than 50 mm;
non-fine aggregates not belonging to the category of fillers described above.

Such aggregates are used to obtain greater strength, lower porosity and low efflorescence. The aggregates may be appropriately chosen from calcareous, quartz or silico-calcareous aggregates, in any form, such as crushed or spherical. As described in WO2013/037792, the relative percentage amount of aggregates of different size is then optimised to obtain the desired low roughness. Some aggregates, as in the case of coloured marble powders, also be used for appearance purposes; more specifically, they can confer particular chromatic features and hues or veining to the product, thus reproducing the appearance of natural stone.

Other components of the composition of the invention are chosen from: organic and/or inorganic pigments; materials having pozzolanic activity, such a preferably microsilica, fly ash, metakaolin, natural pozzolans; materials having latent hydraulic activity, such as ground-granulated blast-furnace slag; hydrated lime; natural lime.

III. For the purposes of the present invention, the initial cementitious composition must contain at least one anti-shrinkage agent or additive having the capability of reducing hygrometric shrinkage, in liquid phase or in solid phase.

The addition of the anti-shrinkage agent also promotes a greater adhesion of the material to the surface of the mould with consequent homogeneity of the surface, with the object of respecting the requirement surface roughness of <500 nm. Such anti-shrinkage agents, also known as SRA (shrinkage reducing agent), include a wide variety of glycols and polyols and are also responsible for reducing the shrinkage deformation for the entire working life of the cured product. In combination with them, lime in form of oxide may be added.

As examples of suitable commercial products as anti-shrinkage agent III we can mention Glycol SRA 04 (Neuvendis) solid powder and Cimparement (Sika) in aqueous solution, a liquid additive made of a mixture of synthetic polymers and ethers.

IV. According to the present invention, the initial cementitious composition must contain at least one superplasticiser agent or additive, preferably polycarboxylic orpolystearic esters, added either in solid phase or in form of aqueous solution.

As examples of suitable commercial products as superplasticiser agents we can mention Melflux 2641 F (BASF) modified polycarboxylic ester in solid form or Viscocrete (Sika) modified polystearic ester.

V. The cementitious mixture which is the object of the present invention comprises fibres made of an amorphous metal material consisting of an alloy with the composition (Fe, Cr)₈₀, (P, C, Si)₂₀ in form of flexible lamellae of a length equal to at least 10 mm and elastic modulus equal to at least 80000 MPa which are added to the cementitious mixture in amounts by weight of less than 4% with respect to the weight of the composition.

A lamella means a lamellar shape in which the section is substantially rectangular and the length is greater than the width and must greater than the thickness, the latter being in the order of microns, e.g. not limitedly from 20 and 30 micron. The so-called “aspect ratio” of the fibre is the ratio between its length L and the equivalent diameter d_{eq}. Being the fibre according to the invention lamellar, the equivalent diameter is in this case defined according to the following formula:

$${d}_{eq} = \sqrt{\frac{4 \cdot width \cdot thickness}{π}}$$

In a preferred composition according to the invention, the number of fibres per cubic metre of composition (mortar) is at least 1.15e+07.

The following table shows the technical properties of some preferred fibres according to the invention and the respective cementitious compositions which contain them, described by way of non-limiting example.

| | | | | | | Fibre | Elastic |
|---|---|---|---|---|---|---|---|
| | Fibre | Length | Density | No. of | Aspect | surface | modulus |
| Trade name | structure | (mm) | (kg/m³) | fibres/kg | ratio | (mm²) | (MPa) |
| Fibraflex FF | Amorphous | 15 | 7200 | 385000 | 85.8 | 31 | 130000 |
| 15 E0 fibres | metal | | | | | | |
| Fibraflex FF | Amorphous | 20 | 7200 | 275000 | 114.4 | 41 | 130000 |
| 20 E0 fibres | metal | | | | | | |
| Fibraflex FF | Amorphous | 20 | 7200 | 150000 | 82.3 | 65 | 130000 |
| 20 L6 fibres | metal | | | | | | |

| | | | | Total |
|---|---|---|---|---|
| | | | | surface |
| | % weight/ | | | fibres/ |
| | weight | No. of | | mortar |
| | of the | fibres/m³ | Surface of | volume |
| Trade name | composition | of mortar | single fibre (m²) | (m²/m³) |
| Fibraflex FF 15 | 1.3 | 1.15e+07 | 31 × 10⁻⁶ | 356.50 |
| E0 fibres | | | | |
| Fibraflex FF 20 | 1.3 | 8.25e+06 | 41 × 10⁻⁶ | 338.25 |
| E0 fibres | | | | |
| Fibraflex FF 20 | 1.3 | 4.5e+06 | 65 × 10⁻⁶ | 292.5 |
| L6 fibres | | | | |

As known, the amorphous structure is obtained in amorphous metals by means of an ultra-rapid cooling procedure of the molten mass, which, by preventing the formation of crystals, confers a vitreous property to the metal material structure. The metal alloy is melted and cast into a high-speed, undercooled rotating centrifuge; the metal thus undergoes a sudden thermal change which may reach a thousand degrees a second. In the molten alloy, the atoms move in random manner and do not have a short or a long range order; the sudden cooling causes the atoms of the metal to freeze in a disorderly position, not allowing them to arrange according to the Bravais lattice. Reference should be made to the aforementioned FR 2765212 for other structural and dimensional properties and for the forming method of the fibres according to the invention.

With reference to the composition according to the invention in general, the combined use of said components makes it possible to optimise the desired rheological features, with a low water-binding ratio, i.e. the ratio between the total amount of water used in the formation of the composition and the amount of hydraulic binder I as described above, and to considerably decrease the hygrometric shrinkage after moulding measured up to 28 days.

In order to limit water absorption by capillarity in the final product, the cementitious composition according to the present invention may contain at least one waterproofing or hydrophobising agent or additive. Such agents include a wide range of compounds of organic or organo-silica nature. According to a preferred aspect of the invention, sodium oleate is used as waterproofing additive, such as the marketed product Ligaphob N(T) 90 (Peter Greven), in powder, or an alkoxysilane, such as the commercial product Seal 200 (Elotex) in solid form.

In additional to the aforesaid components, the composition in form of pourable grout used to make the product which is the object of the present invention may contain various other additives to finely adapt the properties of the binding to the specific application. Examples of such additives may be setting regulators or rheology or physical-mechanical property modifiers, such as for example celluloses or latexes, expansive, aerating or de-aerating agents. Such additives are optional.

The initial fluidity of the composition of the invention is determined by using a method devised by the Applicant according to standard UNI 7044 (1972); such a method envisages filling a truncated-cone-shaped mould placed on a glass plate. The measurement envisages the filling of the mould with the mortar, subsequently lifting and measuring the consequent spreading of the mortar, 60 seconds after having lifted the filled truncated-cone-shaped mould. The measured spreading diameter is the fluidity value, also see accompanying FIG. 4 described below. This measurement is performed without applying mechanical shaking.

According to this measuring method, the initial fluidity of the composition of the invention must be not lower than 185 mm, preferably not lower than 220 mm, more preferably not lower than 240 mm.

The low fragility of the finished products made with a composition of the present invention is evaluated by means of mechanical flexural strength measurements of the composition performed according to standard ASTM C1018-97, with the sole difference that 4×4×16 cm size specimens are used for the materials which are the object of the present invention instead of the 10×10×40 cm specimens described in the standard.

The small size of the specimens requires the measurement to be performed with a distance equal to 12 cm between two resting points, instead of the 35 cm distance envisaged by the concerned standard.

The low fragility of the material is evaluated in terms of deformation energy absorption by means of the load-displacement curve obtained from the three-point test. The width of the subintended area is an indicator of the deformation capacity and consequently of the low fragility of the material. In particular, a MTS Insight—30 Kn Standard Length apparatus with displacement control was used for the materials which are the object of the present invention. The load curve is integrated on a displacement from 0 to 2 mm by applying the trapezoidal rule in order to evaluate the deformation energy absorption.

In the products according to the present invention, the topographic properties of the cementitious product, such as the arithmetic average surface roughness, Ra, is measured by means of a non-contact optical profiler, such as 3D Talysurf CCI Lite (Taylor-Hobson), provided with automatic stage and autofocus. The system uses scanned green light interferometry to obtain images and measurements of the analysed parts, providing qualitative information on the surface structure without physical contact with them. The characterising 3D data of the surface which can be obtained are the following: height parameters: Sq, SSk, Sku, Sp, Sv, Sz, Sa, defined according to standard ISO 25178; planarity parameters: FLTt, FLTp, FLTv, FLTq defined according to standard ISO 12781.

The 2D data characterising the surface which can be obtained using the described technique are the following:

height parameters—roughness profile: Rp, Rv, Rz, Rc, Rt, Ra, Rq, Rsk, Rku, defined according to standard ISO 4287; spacing parameters—roughness profile: RSm, Rdq, defined according to standard ISO 4287; peak count roughness parameters: RPc, defined according to standard ISO 4287.

In order to describe the present invention in greater detail, the following non-limiting examples are shown also with reference to the accompanying figures.

### DESCRIPTION OF THE FIGURES

FIG. 1 shows a complex shaped, injection-moulded product having appearance properties according to the present invention.

FIG. 2 shows the situation described in Example 5 below according to the present invention.

FIG. 3 shows the situation described in comparison Example 6 below.

FIG. 4 shows the situation described in comparison Example 4, also with reference to the aforesaid method devised by the Applicant for measuring fluidity according to standard UNI 7044.

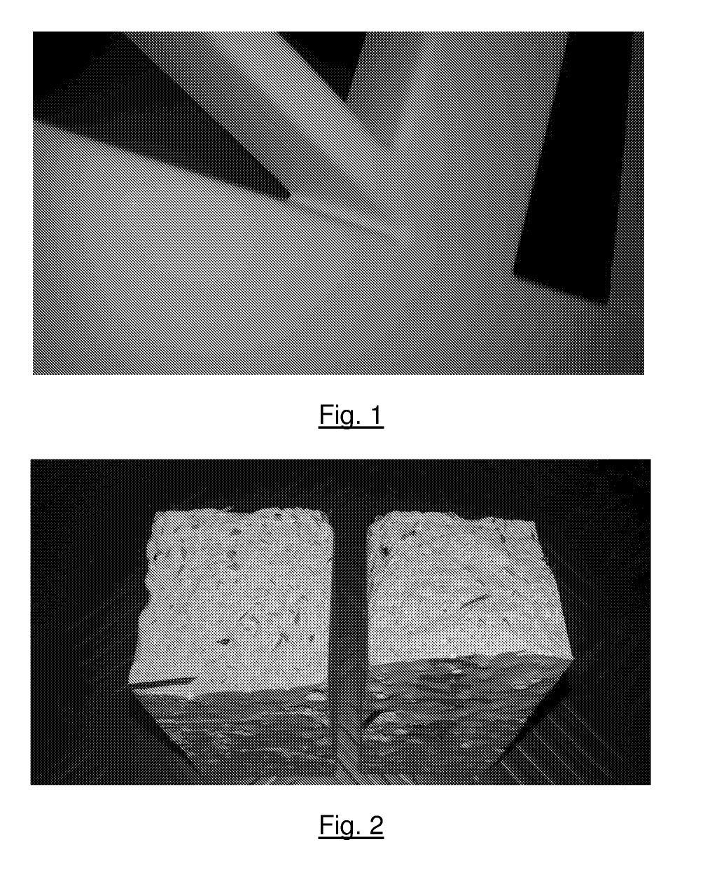

### EXAMPLES

Specific reference will be made in the following examples to fibres according to the invention and to comparison (cfr) fibres not included within the scope invention which have the properties summarised in the following tables:

| | | | | | | Fibre | Elastic |
|---|---|---|---|---|---|---|---|
| | Fibre | Length | Density | No. of | Aspect | surface | modulus |
| Trade name | structure | (mm) | (kg/m³) | fibres/kg | ratio | (mm²) | (MPa) |
| Fibraflex FF | Amorphous | 15 | 7200 | 385000 | 85.8 | 31 | 130000 |
| 15 E0 fibres | metal | | | | | | |
| Fibraflex FF | Amorphous | 20 | 7200 | 275000 | 114.4 | 41 | 130000 |
| 20 E0 fibres | metal | | | | | | |
| Fibraflex FF | Amorphous | 20 | 7200 | 150000 | 82.3 | 65 | 130000 |
| 20 L6 fibres | metal | | | | | | |
| Kuraray. | PVA (cfr) | 8 | 1300 | 7.65 × 10⁷ | 200 | 1.00 | 41000 |
| Kuralon | | | | | | | |
| RECS15 | | | | | | | |

| | | | | Total |
|---|---|---|---|---|
| | | | | surface |
| | % weight/ | | | fibres/ |
| | weight | No. of | Surface | vol. of |
| | of the | fibres/m³ of | of single | mortar |
| Trade name | composition | mortar | fibre (m²) | (m²/m³) |
| Fibraflex FF 15 | 1.3 | 1.15e+07 | 31 × 10⁻⁶ | 356.50 |
| E0 fibres | | | | |
| Fibraflex FF 20 | 1.3 | 8.25e+06 | 41 × 10⁻⁶ | 338.25 |
| E0 fibres | | | | |
| Fibraflex FF 20 | 1.3 | 4.5e+06 | 65 × 10⁻⁶ | 292.5 |
| L6 fibres | | | | |
| Kuraray Kuralon | 0.24 | 4.22e+08 | 1 × 10⁻⁶ | 422 |
| RECS15 | | | | |

### Example 1

### Injection Moulding

The following solid components were mixed in an intensive Hobart type mixer for three minutes:

| | % amount |
|---|---|
| COMPONENTS | by weight |
| Binder I: cement (i.active ultra 52,5R Italcementi) | 17.1 |
| Aggregate II: lime filler (dmax up to 50 pm) | 17.9 |
| Aggregate II: lime aggregate (dmax >50 μm) | 54.5 |
| Superplasticiser agent IV: polycarboxylic (Melflux 2641 | 0.2 |
| F-BASF) | |
| Hydrophobising agent: alkoxysilane (Seal 200 Elotex) | 0.3 |
| Anti-shrinkage agent III: glycol(SRA 04 - Neuvendis) | 0.5 |
| De-aerating agent: polyglycol (Agitan P845 - Munzing | 0.1 |
| Chemie) | |
| Water | 9.4 |

After adding water, the mixture thus obtained was mixed for four minutes (as a function of the features of the mixer and of the external temperature). After this time, the fluidity of the mixture was measured as described above, and found to be equal to 319 mm.

At this point, amorphous metal fibres (Saint Gobain Fibraflex FF 20 E0) were added in percentage by volume equal to 0.42% with respect to the volume of the mixture, corresponding to a percentage by weight of 1.4%, and the mixing was protracted for other two minutes at slow speed. After this time, the fluidity of the mixture with the fibres was measured as described above, and found to be equal to 301 mm.

So, 4×4×16 specimens were prepared according to EN 196-1, “Methods of testing cement—Determination of strength”, and then subjected to flexural test according to standard ASTM C1018-97 modified as described above.

The data obtained from the flexural tensile strength test were processed to obtain the total tensile strength energy. The obtained tensile strength energy was equal to 2.59 J (N·m), with respect to 0.30 J of a comparison specimen obtained from the same mixture but without the addition of fibres.

The fresh mortar with fibres as obtained above was injected by means of Duplex Bredel model SPX80D peristaltic pump into rectangular section moulds having a void degree (void volume/total volume) equal to 50%, size 4 m×4.20 m and thickness 16 cm. The high fluidity made it possible to obtain the homogenous filling of the mould obtaining a fault-free product. The surface roughness measurement, expressed as Ra according to standard ISO 4287, was equal to 120 nm.

### Example 2

### Injection Moulding

The solid components of example 1 were mixed in an intensive Hobart type mixer for three minutes. After adding water, the mixture thus obtained was mixed for four minutes (as a function of the features of the mixer and of the external temperature). After this time, the fluidity of the mixture was measured as described above, and found to be equal to 309 mm.

At this point, amorphous metal fibres (Saint Gobain Fibraflex FF 20 L6) were added in percentage by volume equal to 0.42% with respect to the volume of the mixture, corresponding to a percentage by weight of 1.4%, and the mixing was protracted for other two minutes at slow speed.

After this time, the fluidity of the mixture with the fibres was measured as described above, and found to be equal to 299 mm.

So, 4×4×16 specimens were prepared according to EN 196-1, “Methods of testing cement—Determination of strength”, and then subjected to flexural test according to standard ASTM C1018-97 modified as described above.

The data obtained from the flexural tensile strength test were processed to obtain the total tensile strength energy.

The obtained tensile strength energy was equal to 1.39 J (N·m), with respect to 0.30 J of a comparison specimen obtained from the same mixture but without the addition of fibres.

The fresh mortar with fibres as obtained above was injected by means of Duplex Bredel model SPX80D peristaltic pump into curvilinear section moulds having a void degree (void volume/total volume) equal to 40%, size 3 m×2.20 m and thickness 8 cm. The high fluidity makes it possible to obtain the homogenous filling of the mould obtaining a fault-free product. The surface roughness measurement, expressed as Ra according to standard ISO 4287, is equal to 125 nm.

### Example 3

### Comparison

The solid components of example 1 were mixed in an intensive Hobart type mixer for three minutes.

After adding water, the mixture thus obtained is mixed for four minutes (as a function of the features of the mixer and of the external temperature). After this time, the fluidity of the mixture was measured as described above, and found to be equal to 307 mm.

At this point, the comparison fibres were added, made of PVA (Kuraray Kuralon RECS15), in percentage by volume equal to 0.42% with respect to the volume of the mortar and mixing was protracted for other two minutes at slow speed.

After this time, the fluidity of the mixture with the PVA fibres was measured as described above, and found to be equal to 181 mm.

So, 4×4×16 specimens were prepared according to EN 196-1, “Methods of testing cement—Determination of strength”, and then subjected to flexural test according to standard ASTM C1018-97 modified as described.

The data obtained from the flexural tensile strength test were processed to obtain the total tensile strength energy. The obtained tensile strength energy was equal to 0.6 J (N·m), with respect to 0.30 J of a comparison specimen obtained from the same mixture but without the addition of fibres.

The fresh mortar with PVA fibres thus obtained could not be worked by means of the Duplex Bredel model SPX80D peristaltic pump. The poor fluidity did not allow the uniform filling of the mould.

### Example 4

### Comparison

Example 1 was repeated with the difference that the same amorphous metal fibres (Saint Gobain Fibraflex FF 20 E0) were added in percentage by weight of 4% with respect to the weight of the mixture.

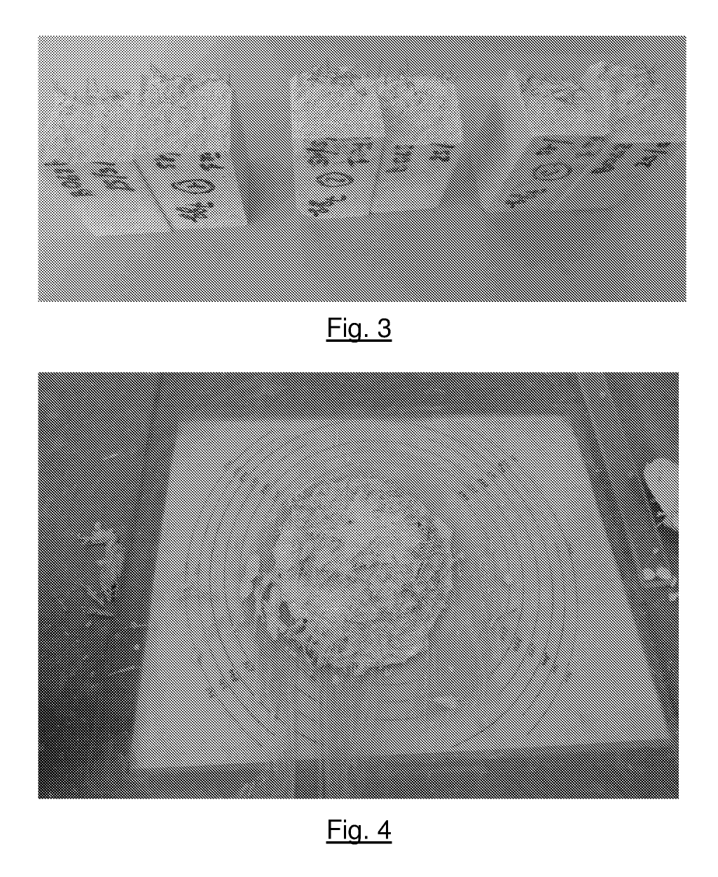

The corresponding fluidity measurements of the cementitious mixture were 310 mm in case of mortar free from fibres and 135 mm after the addition of fibres, as shown in FIG. 4.

Specimens made with such a mixture with fibres in percentage by weight with 4% demonstrated the infeasibility of injection moulding, visible separation of the fibres themselves from the cementitious matrix, as shown again in FIG. 4, and loss of all limits of roughness and of the respective appearance result.

### Example 5

### Casting Moulding

The following solid components were mixed in an intensive Hobart type mixer for three minutes:

| | % by |
|---|---|
| COMPONENTS | weight |
| Binder I: cement (i.active ultra 52,5R Italcementi) | 17.0 |
| Aggregate II: lime filler (dmax up to 50 μm) | 17.9 |
| Aggregate II: lime aggregate (dmax >50 μm) | 54.5 |
| Superplasticiser agent IV: polycarboxylic (Melflux 2641 | 0.2 |
| F-BASF) | |
| Hydrophobising agent: alkoxysilane (Seal 200 Elotex) | 0.3 |
| Anti-shrinkage agent III: glycol(SRA 04 - Neuvendis) | 0.5 |
| De-aerating agent: polyglycol (Agitan P845 - Munzing Chemie) | 0.1 |
| Water | 9.4 |

After adding water, the mixture thus obtained was mixed for four minutes (as a function of the features of the mixer and of the external temperature). After this time, the fluidity of the mixture was measured as described above, and found to be equal to 318 mm.

At this point, amorphous metal fibres (Saint Gobain Fibraflex FF 15 E0) were added in percentage by volume equal to 0.42% with respect to the volume of the mixture, corresponding to a percentage by weight of 1.3%, and the mixing was protracted for other two minutes at slow speed. After this time, the fluidity of the mixture with the fibres was measured as described above, and found to be equal to 285 mm.

So, 4×4×16 specimens were prepared according to UNI EN 196-1, “Methods of testing cement—Determination of strength”, and then subjected to flexural test according to standard ASTM C1018-97 modified as described.

The data obtained from the flexural tensile strength test were processed to obtain the total tensile strength energy. The obtained tensile strength energy was equal to 1.2 J (N·m), with respect to 0.30 J of a comparison specimen obtained from the same mixture but without the addition of fibres.

The surface roughness measurement, expressed as Ra according to standard ISO 4287, was equal to 150 nm.

The fresh mortar with fibres as obtained above was cast into a rectangular section mould having a void degree (void volume/total volume) equal to 50%, size 4 m×4 m and thickness 16 cm. After having caused the flexural failure of the product thus moulded, a homogenous dispersion of the amorphous metal fibres, satisfactory for the purposes of the invention, could be observed in section, shown in FIG. 2.

### Example 6

### Comparison

The solid components of example 5 were mixed in an intensive Hobart type mixer for three minutes.

After adding water, the mixture thus obtained was mixed for four minutes (as a function of the features of the mixer and of the external temperature). After this time, the fluidity of the mixture was measured as described above, and found to be equal to 305 mm.

At this point, size 0.35×18 mm steel fibres were added (commercial product: Matassina La Gramigna 18), in percentage by volume equal to 0.42% with respect to the volume of the mixture, corresponding to a percentage by weight of 1.4%, and the mixing was protracted for other two minutes at slow speed. After this time, the fluidity of the mixture with the steel fibres was measured as described above, and found to be equal to 303 mm.

So, 4×4×16 specimens were prepared according to EN 196-1, “Methods of testing cement—Determination of strength”, and then subjected to flexural test according to standard ASTM C1018-97 modified as described.

The data obtained from the flexural tensile strength test were processed to obtain the total tensile strength energy. The obtained tensile strength energy value was equal to 1.94 J (N·m), with respect to 0.30 J of a comparison specimen obtained from the same mixture but without the addition of fibres. However, a layering of the fibres was observed on the bottom of the mould after the failure of the specimens, indicating a non-homogenous distribution of the fibres in the high-fluidity cementitious mixture. FIG. 3 shows that the fibres visibly emerge in the failure section.

In general, the finished products obtained from a composition of the invention may vary in a wide range of shapes and dimensions, including thickness, provided that the essential requirements according to the invention as described above are respected, i.e. the products can be injection moulded, are homogenous and smooth to the touch, have a homogenous colour, do not display faults, such as air bubbles, shrinkage crazing or curling, and have the desired mechanical properties as a whole.

Examples of product applications thus made are: cladding panels for continuous and ventilated façades, panels for fencing, marquises, flooring sheets and tiles, sunshade elements, sun protection systems, furniture items, vertical partition elements.

1. A cementitious composition suitable to be moulded by injection, to produce a manufactured product with arithmetic average surface roughness Ra not higher than 500 nm and flexural tensile strength not lower than 5 MPa, measured after 28 days of curing, the fluidity of the composition being not lower than 185 mm, wherein it comprises at least:
I. a hydraulic binder
II. one or more aggregates
III. an anti-shrinkage agent
IV. a superplasticiser agent
V. fibres
VI. water,
wherein said fibres are made of an amorphous metal material consisting of a alloy with the composition (Fe, Cr)₈₀ (P, C, Si)₂₀ in the form of flexible lamellae of a length equal to at least 10 mm and elastic modulus equal to at least 80000 MPa, present in the composition in amounts by weight of less than 4% with respect to the weight of the composition.

2. The composition according to claim 1, wherein said fibres are present in the composition in an amount comprised between 1% and 2% with respect to the weight of the composition.

3. The composition according to claim 1, wherein said fibres are present in the composition in an amount comprised between 1.3% and 1.4% with respect to the weight of the composition.

4. The composition according to claim 1, wherein the number of fibres per cubic metre is at least 1.15e+07.

5. The composition according to claim 1, wherein said fibres have the following properties:

| | | | | | | Fibre | Elastic |
|---|---|---|---|---|---|---|---|
| | Fibre | Length | Density | no of | Aspect | surface | modulus |
| Trade name | structure | (mm) | (Kg/m³) | fibres/Kg | ratio | (mm²) | (MPa) |
| Fibraflex FF | Amorphous | 15 | 7200 | 385000 | 85.8 | 31 | 130000 |
| 15 E0Fibres | metal | | | | | | |
| Fibraflex FF | Amorphous | 20 | 7200 | 275000 | 114.4 | 41 | 130000 |
| 20 E0Fibres | metal | | | | | | |
| Fibraflex FF | Amorphous | 20 | 7200 | 150000 | 82.3 | 65 | 130000 |
| 20 L6Fibres | metal | | | | | | |

6. The composition according to claim 5, wherein it comprises said fibres according to the following properties:

| | | | | Total |
|---|---|---|---|---|
| | | | | surface |
| | % weight/ | | | fibres/ |
| | weight | n^{o} fibres/ | | mortar |
| | of the | m³ of | Surface of | volume |
| Trade name | composition | mortar | single fibre (m²) | (m²/m³) |
| Fibraflex FF 15 | 1.3 | 1.15e+07 | 31 × 10⁻⁶ | 356.50 |
| E0Fibres | | | | |
| Fibraflex FF 20 | 1.3 | 8.25e+06 | 41 × 10⁻⁶ | 338.25 |
| E0Fibres | | | | |
| Fibraflex FF 20 | 1.3 | 4.5e+06 | 65 × 10⁻⁶ | 292.5 |
| L6Fibres | | | | |

7. The composition according to claim 1, wherein it comprises as anti-shrinkage agent III. at least one compound selected from glycols, polyols, a mixture of synthetic polymers and ethers.

8. The composition according to claim 7, wherein it comprises in combination with said anti-shrinkage agent III. lime in the form of oxide.

9. The composition according to claim 1, wherein it comprises as superplasticiser agent IV. a compound selected from polycarboxylic ester and polystearic ester.

10. A method for the preparation of a cementitious composition comprising at least one hydraulic binder, one or more aggregates, an anti-shrinkage agent, a superplasticiser agent, fibres and water, suitable to be moulded by injection to produce a manufactured product with arithmetic average surface roughness Ra not higher than 500 nm and flexural tensile strength not lower than 5 MPa, measured after 28 days of curing, the fluidity of the composition being not lower than 185 mm, wherein said fibres are made of an amorphous metal material consisting of an alloy with the composition (Fe, Cr)₈₀ (P, C, Si)₂₀ in the form of flexible lamellae of a length equal to at least 10 mm and elastic modulus equal to at least 80000 MPa, present in the composition in amounts by weight of less than 4% with respect to the weight of the composition.

11. A method for forming a manufactured product with arithmetic average surface roughness Ra not higher than 500 nm and flexural tensile strength not lower than 5 MPa, measured after 28 days of curing, characterised by subjecting to injection under pressure in a range between 0.1 and 50 bar a cementitious composition comprising at least:
I. a hydraulic binder
II. one or more aggregates
III. an anti-shrinkage agent
IV. a superplasticiser agent
V. fibres
VI. water,
wherein said fibres are made of an amorphous metal material consisting of an alloy with the composition (Fe, Cr)₈₀ (P, C, Si)₂₀ in the form of flexible lamellae of a length equal to at least 10 mm and elastic modulus equal to at least 80000 MPa, present in the composition in amounts by weight of less than 4% with respect to the weight of the composition, the fluidity of the composition being not lower than 185 mm.
